(19) United States
(12) Patent Application Publication
(10) Pub. No.: US 2014/0358612 A1
(43) Pub. Date: Dec. 4, 2014

(54) METHOD AND APPARATUS FOR MANAGING VISITOR INTERACTIONS

(71) Applicant: 24/7 Customer, Inc., Campbell, CA (US)

(72) Inventors: Mathangi SRI, Bangalore (IN); Rakesh Reddy, Bangalore (IN); Pallipuram V. Kannan, San Jose, CA (US)

(21) Appl. No.: 14/294,005

(22) Filed: Jun. 2, 2014

Related U.S. Application Data
(60) Provisional application No. 61/830,348, filed on Jun. 3, 2013.

(51) Int. Cl. G06Q 30/00; G06Q 10/06

(52) U.S. Cl. CPC G06Q 30/016; G06Q 10/063114
USPC 705/7.15

(57) ABSTRACT

In accordance with an example embodiment a method and apparatus for managing visitor interactions is provided. The method comprises detecting a website access event corresponding to a visitor. The method further comprises determining, upon detecting the website access event, if an interaction invitation is available from among a maximum number of interaction invitations computed to be offered to visitors for facilitating the visitor interactions with agents. The maximum number of interaction invitations computed based on a number of active agents. The interaction invitation is provided to the visitor if the interaction invitation is determined to be available.

### CROSS REFERENCE TO RELATED APPLICATIONS

This application claims priority to U.S. provisional patent application Ser. No. 61/830,348 filed Jun. 3, 2013, which application is incorporated herein in its entirety by this reference thereto.

### TECHNICAL FIELD

The present technology generally relates to online services and more particularly to managing online visitor interactions.

### BACKGROUND

Websites of enterprises routinely attract visitors, who visit the websites to obtain product information, to receive purchase assistance, to make customer service queries and so forth. In some cases, the websites offer assistance to the visitors by facilitating interaction in form of either a voice or a chat conversation with a customer support representative (also referred to herein as an ‘agent’). The interaction-based assistance is typically offered to visitors without regard to a number of agents available to conduct the visitor interactions. In some scenarios, due to the disproportionate number of offers for interaction-based assistance extended to visitors, some visitors opting for the offered interaction-based assistance may have to wait a long time in a queue due to unavailability of agents. Moreover, in some example scenarios, visitors might, instead of accepting or declining the offer, simply ignore the offer. Such ignored offers for interaction-based assistance may tie up offers that may have been offered to other visitors. Some visitors waiting for an excessive amount of time for an interaction to be initiated may become frustrated and abandon the queue. Such an experience may negatively influence the visitor's mood and even may result in adverse visitor reaction towards the enterprise. Accordingly, there is a need to manage visitor interactions better and thereby enhance a visitor's online experience.

### SUMMARY

Various apparatuses, methods, and computer readable mediums for managing visitor interactions are disclosed. In an embodiment, a computer-implemented method for managing visitor interactions is disclosed. The method includes detecting a website access event corresponding to a visitor. The method further includes determining, upon detecting the website access event, if an interaction invitation is available from among a maximum number of interaction invitations computed to be offered to visitors for facilitating visitor interactions with agents. The maximum number of interaction invitations is computed based on a number of active agents. The interaction invitation is provided to the visitor if the interaction invitation is determined to be available.

In another embodiment, the apparatus for managing visitor interactions is disclosed. The apparatus includes at least one processor and a memory. The memory is adapted to store machine executable instructions therein, that when executed by the at least one processor, cause the apparatus to detect a website access event corresponding to a visitor. The apparatus is further configured to determine, upon detecting the website access event, if an interaction invitation is available from among a maximum number of interaction invitations computed to be offered to visitors for facilitating visitor interactions with agents. The maximum number of interaction invitations is computed based on a number of active agents. The interaction invitation is provided to the visitor if the interaction invitation is determined to be available.

Moreover, in an embodiment, a non-transitory computer-readable medium storing a set of instructions that when executed cause a computer to perform a method for managing visitor interactions is disclosed. The method further includes determining, upon detecting the website access event, if an interaction invitation is available from among a maximum number of interaction invitations computed to be offered to visitors for facilitating visitor interactions with agents. The maximum number of interaction invitations is computed based on a number of active agents. The interaction invitation is provided to the visitor if the interaction invitation is determined to be available.

### BRIEF DESCRIPTION OF THE FIGURES

FIG. 1 is a schematic diagram showing an example online visitor interaction in accordance with an example scenario;

FIG. 2 is a block diagram of an example apparatus configured to manage visitor interactions in accordance with an embodiment;

FIG. 3 is a schematic diagram showing an example provisioning of interaction invitations to one or more visitors in accordance with an embodiment;

FIG. 4 is a first example screenshot of a visitor device screen showing an example interaction invitation provided to a visitor in accordance with an embodiment;

FIG. 5 is a second example screenshot of a visitor device screen showing an example interaction invitation provided to a visitor in accordance with another embodiment;

FIG. 6 is a flow diagram of a first example method for managing visitor interactions in accordance with an embodiment;

FIG. 7 is a flow diagram of a second example method for managing visitor interactions in accordance with an embodiment; and

FIG. 8 is a flow diagram of a third example method for managing visitor interactions in accordance with an embodiment.

### DETAILED DESCRIPTION

FIG. 1 is a schematic diagram 100 showing an example online visitor interaction in accordance with an example scenario. The schematic diagram 100 depicts a website 102 capable of being accessed over a network 104. More specifically, the website 102 may be hosted on a remote web server on the network 104. In an example scenario, the website 102 may be associated with an enterprise offering at least one of a product and a service. The website 102 may routinely attract visitors, such as a visitor 106, who may visit the website 102 for a variety of reasons, such as for example, to obtain information about the product and/or service, to receive purchase assistance, to make customer service queries and so forth. The term ‘visitor’ (also referred to herein as an ‘online visitor’) refers to an individual currently accessing at least one webpage from among one or more pages associated with the website 102. The visitor 106 is associated with an electronic device 108 configured to facilitate access to the website 102 over the network 104. Examples of the network 104 may include wired networks, wireless networks or a combination thereof. Examples of wired networks may include Ethernet, local area network (LAN), fiber-optic cable network and the like. Examples of wireless network may include cellular networks like GSM/3G/CDMA networks, wireless LAN, Bluetooth or Zigbee networks and the like. An example of a combination of wired and wireless networks may include the Internet. In FIG. 1, the electronic device 108 is depicted to be a laptop. However it is understood that the electronic device 108 may be any such electronic device capable of facilitating network access. Other examples of the electronic device 108 may include, but are not limited to, a personal computer, a Smartphone, a tablet computer, a personal digital assistant, a mobile phone, a Smart watch, web-enabled pair of glasses and the like.

In an example scenario, an enterprise associated with the website 102 may offer assistance to visitors on the website 102 for example, for purchasing a product or a service, for answering a visitor query and the like, by facilitating an interaction of the visitor 106 with a customer service representative, such as an agent 110 disposed at a remote customer sale and support (CSS) facility. The interaction facilitated on the website (also referred to as online interaction or visitor interaction) may be embodied as a voice or a chat interaction. The agent 110 may be associated with one or more electronic devices, such as electronic devices 112 and 114 for conducting such interactions with one or more visitors. Examples of the electronic devices 112 and 114 may include personal computers, laptops, mobile phones and the like.

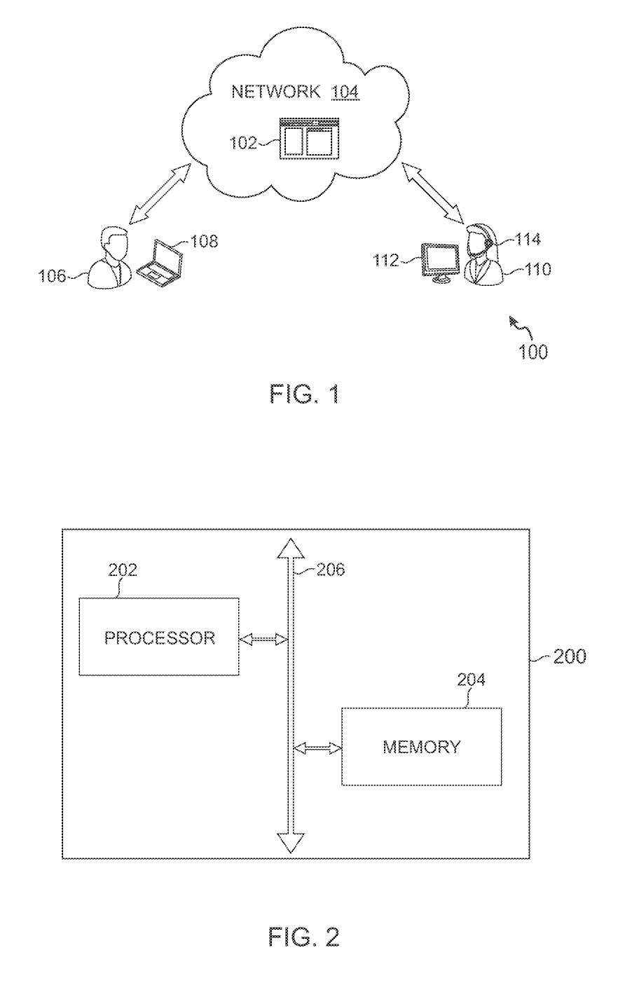

Pursuant to an example scenario, the interaction-based assistance is typically offered to a plurality of visitors, such as the visitor 106, without regard to a number of agents available to conduct the visitor interactions. In some scenarios, due to the disproportionate number of offers for interaction-based assistance extended to the visitors, some visitors opting for the offered interaction-based assistance may have to wait a long time in a queue due to unavailability of agents. Moreover, in some example scenarios, visitors might, instead of accepting or declining the offer, simply ignore the offer for interaction-based assistance. Such ignored offers for interaction-based assistance may tie up offers that may have been offered to other visitors. Some visitors waiting for an excessive amount of time for an interaction to be initiated may become frustrated and abandon the queue. Such an experience may negatively influence the visitor's mood and even may result in adverse visitor reaction towards the enterprise associated with the website 102. Various embodiments of the present technology, however, provide methods and apparatuses for managing visitor interactions that are capable of overcoming these and other obstacles and providing additional benefits. More specifically, methods and apparatuses disclosed herein suggest determining a maximum number of interaction invitations that may be offered to visitors for facilitating visitor interactions with agents based on a number of active agents at any given point of time. For each visitor on a website, an availability of an interaction invitation from among the maximum number of interaction invitations is determined and an interaction invitation is provided to the visitor if the interaction invitation is determined to be available. An example apparatus configured to manage visitor interactions is explained with reference to FIG. 2.

FIG. 2 is a block diagram of an example apparatus 200 configured to manage visitor interactions in accordance with an embodiment. In an embodiment, the apparatus 200 may be embodied as a web server communicably associated with visitors on a website, such as the website 102 of FIG. 1, and the plurality of agents, such as the agent 110 of a CSS facility associated with an enterprise corresponding to the website. Pursuant to an exemplary scenario, the apparatus 200 may be any machine capable of executing a set of instructions (sequential and/or otherwise) so as to manage visitor interactions.

The apparatus 200 includes at least one processor, such as the processor 202 and a memory 204. It is noted that though the apparatus 200 is depicted to include only one processor, the apparatus 200 may include more number of processors therein. In an embodiment, the processor 202 and the memory 204 are configured to communicate with each other via or through a bus 206. Examples of the bus 206 may include, but are not limited to, a data bus, an address bus, a control bus, and the like. The bus 206 may be, for example, a serial bus, a bi-directional bus or a unidirectional bus.

In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed. The processor 202 may include, among other things, a clock, an arithmetic logic unit (ALU) and logic gates configured to support an operation of the processor 202. The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

In an embodiment, the processor 202 is configured to, with the content of the memory 204, cause the apparatus 200 to detect a website access event corresponding to a visitor, such as the visitor 106 of FIG. 1. In an illustrative example, one or more tracking cookies may be linked to a website corresponding to the website access event by the apparatus 200. The website access event by the visitor may trigger a downloading of the one or more tracking cookies into a web browser storage associated with the visitor's electronic device (also referred to herein as visitor device), thereby facilitating detection of the website access event corresponding to the visitor. It is noted that such an example of detection of the website access event is included herein for illustration purposes and one or more such standard techniques may be employed by the apparatus 200 for detection of the website access event. For example, the apparatus 200 may be configured to track a uniform resource locator (URL) based connection request at a web server hosting the website for detecting the website access event.

In an embodiment, the processor 202 is configured to, with the content of the memory 204, cause the apparatus 200 to determine, upon detecting the website access event, if an interaction invitation is available for offering assistance to the visitor. As explained with reference to FIG. 1, some websites may offer assistance to visitors visiting the website in form of interaction with customer service representatives or agents. The offer for assistance may be embodied in form of an interaction invitation. In an embodiment, the interaction invitation corresponds to an invitation for facilitating one of a chat interaction and a voice interaction with an active agent. The term ‘active agent’ refers to an agent, who is currently available for handling an interaction with a visitor.

In an embodiment, prior to providing the interaction invitation to a visitor, the processor 202 is configured to, with the content of the memory 204, cause the apparatus 200 to compute a maximum number of interaction invitations to be offered to visitors for facilitating the visitor interactions with agents. In an embodiment, the maximum number of interaction invitations is computed based on the number of active agents at any given point of time. More specifically, the apparatus 200 is configured to determine a maximum number of visitor interactions capable of being handled by one or more active agents associated with the number of active agents at a given instance of time (for example, a current instance of time or any subsequent instance of time). In some cases, the one or more active agents are capable of interacting concurrently with two or more visitors. For example, if a nature of interaction is chosen to be a chat interaction and if each active agent may concurrently chat with one or more visitors, then the maximum number of interaction invitations may be computed based on a number of concurrent visitor interactions capable of being handled by the active agents. For example, if a number of active agents is five and each of the five active agents can handle five chat interactions with visitors, then the maximum number of visitor interactions may be computed to be 25 (for example, five active agents with each active agent handling five interactions). In another embodiment, if a nature of interaction is chosen to be a voice interaction, then each active agent may interact with only visitor at given time (i.e. concurrency is one). Accordingly, the maximum number of interaction invitations may be computed based on a number of active agents. For example, if a number of active agents is five, then the maximum number of visitor interactions may be computed to be five.

In an embodiment, a pre-determined average acceptance time and a pre-determined average wait time associated with visitor interactions may be taken into account while determining the maximum number of visitor interactions. The term ‘average acceptance time’ as used herein refers to an average time (for example in seconds) taken by a visitor to provide acceptance (or rejection) of the offered interaction invitation. The term ‘average wait time’ as used herein refers to an average time (for example in seconds) a visitor waits in a queue for interaction with an agent. The average acceptance time and the average wait time may be pre-determined based on variety of factors. For example, the average acceptance time and the average wait time may be pre-determined based on empirical data associated with historic interaction invitations offered to visitors. In an embodiment, a sum of the pre-determined average acceptance time and the pre-determined average wait time associated with visitor interactions is taken into account while determining the maximum number of visitor interactions. For example, if one or more visitors have been previously offered with interaction invitations, then for a new visitor, given one or more factors, such as a time of the day, the visitor's probable position in a queue, nature of the product/service being sold and the like, an appropriate pre-determined average acceptance time and the pre-determined average wait time is determined A sum of the pre-determined average acceptance time and the pre-determined average wait time is then computed. The sum of the pre-determined average acceptance time and the pre-determined average wait time is indicative of a time instance at which the visitor accepts the interaction invitation. Accordingly, the maximum number of visitor interactions at the time instance at which the visitor accepts the interaction invitation may be determined. In an illustrative example, if five visitors have been previously offered interaction invitations, then for a new visitor (i.e. a sixth visitor), an appropriate pre-determined average acceptance time (say ‘X’ seconds) and the pre-determined average wait time (say ‘Y’ seconds) is determined. The sum of pre-determined average acceptance time and the pre-determined average wait time, i.e. ‘X+Y’ seconds represents the time instance at which the visitor may accept the interaction invitation. Accordingly, the maximum number of interaction invitations may be computed after ‘X+Y’ seconds. More specifically, the availability of active agents at the time instance at which the visitor may accept the interaction invitation may be taken into account while determining the maximum number of visitor interactions.

In an embodiment, the processor 202 is further configured to, with the content of the memory 204, cause the apparatus 200 to determine an acceptance rate indicative of a rate of acceptance of one or more previously offered interaction invitations. In an embodiment, if ‘N₁’ is the number of interaction invitations offered to visitors and ‘N₂’ is the number of interaction invitations accepted by the visitors from among ‘N₁’ offered interaction invitations, then the acceptance rate denoted by ‘R’ may be determined as depicted in equation (1) below:

$$R = \frac{{N}_{2}}{{N}_{1}} \qquad ( 1 )$$

For example, if ten interaction invitations are offered to visitors and only five of the offered interaction invitations are accepted by the visitors, then the acceptance rate may be determined to be 5/10 or 0.5. In an embodiment, the acceptance rate may vary based on the time of the day or the day of the week. Accordingly, the apparatus 200 is configured to determine the acceptance rate by taking appropriate historical data into consideration.

In an embodiment, the maximum number of interaction invitations is computed based on the maximum number of visitor interactions and the acceptance rate. In an illustrative example, if the maximum number of visitor invitations is denoted by the term ‘Max_count’ and the acceptance rate is denoted by ‘R’, then the maximum number of interaction invitations denoted by the term ‘Max_invites’ is determined as depicted in equation (2) below:

$$Max\_invites = \frac{Max\_count}{R} \qquad ( 2 )$$

For example, if maximum number of visitor invitations capable of being handled by the number of active agents is ten and the acceptance rate is 0.5, then maximum number of interaction invitations that may be offered to visitors may be computed to be 10/0.5 or 20.

In an embodiment, the processor 202 is configured to, with the content of the memory 204, cause the apparatus 200 to determine a counter value indicative of a number of interaction invitations currently offered to one or more visitors. More specifically, the apparatus 200 is configured to continuously keep track of a number of interaction invitations that are being offered to visitors as well as a status of those interaction invitations (for example, one of an accepted, declined or ignored status). Upon detecting the website access event, a comparison of the counter value with the maximum number of interaction invitations is performed. If the counter value is less than the maximum number of interaction invitations, then an interaction invitation is determined to be available for facilitating interaction between the visitor and an active agent. However, if the counter value is at least equal to the maximum number of interaction invitations, then the interaction invitation is determined to be unavailable and the interaction invitation is not extended to the visitor.

In an embodiment, the processor 202 is configured to, with the content of the memory 204, cause the apparatus 200 to compute a visitor score corresponding to the visitor upon detecting the website access event. In an embodiment, the visitor score is computed based on pre-defined parameters. In an embodiment, the pre-defined parameters correspond to at least one of a predicted visitor's interest in availing at least one of a product and a service associated with the website, a past purchasing history associated with the visitor, a web journey associated with the visitor, a visitor profile information and time spent on one or more web pages associated with the website by the visitor.

In an embodiment, the memory 204 is configured to store information stored related to the visitors. The stored information related to the visitors may include, but is not limited to, visitor profile information, information related to visitor interests and preferences, recent transactions, past interaction with agents, website surfing patterns and the like. In an embodiment, the apparatus 200 may be communicably associated with a prediction engine. In an embodiment, the prediction engine may be externally disposed to the apparatus 200 and may be configured to be in remote communication with the apparatus 200. In another embodiment, the prediction engine may be included within the apparatus 200. The prediction engine is configured to mine information corresponding to the visitors stored in the memory 204. The stored information may be subjected to a set of text mining & predictive models (hereinafter collectively referred to as prediction models) for mining relevant information that drive the prediction of the visitor intent. Examples of the prediction models may include, but are not limited to Logistic regression, Naïve Bayesian, Rule Engines, Neural Networks, Decision Trees, Support Vector Machines, k-nearest neighbor, K-means and the like. The prediction models may be configured to extract certain features from past visitor interactions or from the agent interactions or from both visitor and agent interactions. Further, the prediction models may be configured to extract features by utilizing a relationship between the visitor and agent interactions (for example, sentiment of the visitor for a given agent response). Examples of the features that may be fed into the prediction models may include, but are not limited to, any combinations of words features such as n-grams, unigrams, bigrams and trigrams, word phrases, part-of-speech of words, sentiment of words, sentiment of sentences, position of words, customer keyword searches, visitor click data, visitor web journeys, the visitor interaction history and the like. In an embodiment, the prediction models may utilize any combination of the above-mentioned input features along with the visitor interaction data such as, but not limited to, which agent handled the dialogue, what the outcome was, interaction transfers if any and the like to predict the visitor's likely intents. The mined information enables the prediction engine to infer intent of a visitor for being present on the website.

In an embodiment, the processor 202 is configured to retrieve stored information corresponding to the visitor associated with the website access event from the memory 204. The retrieved information may include information such as a past purchasing history associated with the visitor, a web journey associated with the visitor, a visitor profile information and time spent on one or more web pages associated with the website by the visitor and the like. The processor 202 is also configured to receive information such as the predicted intent of the visitor in availing at least one of a product and a service associated with the website from the prediction engine. In an embodiment, the processor 202 is configured to, with the content of the memory 204, cause the apparatus 200 to include the retrieved and received information in a scoring model as parameters and assign appropriate weights to each parameter to generate a visitor score. For example, a higher weight may be assigned to web page related to payments on the website. Accordingly a visitors' web journey on the website involving a visit to the web page related to payments may be assigned a higher weight and accordingly may contribute to a higher visitor score. Similarly, if the visitor has visited the website subsequent to visiting a web page for another website related to best deals on a product or a service, then higher weight may be assigned to such a web journey associated with the visitor, as such a web journey may be indicative of higher propensity of the visitor to make a purchase on the website. It is understood that various combinations of factors may be utilized for assigning weights to various parameters for generating the visitor score and the generation of visitor score may not be limited to examples provided herein.

As explained above, the visitor score indicates if the visitor is a ‘hot lead’ or not, or in other words, how likely is the visitor to make a purchase in the current visit to the website. In an embodiment, the visitor score is computed to be a probabilistic number indicative of the visitor's propensity to make a purchase or avail a service. For example, a visitor score of 70 may indicate a 70 percent probability of the visitor making a purchase in the current visit to the website. Accordingly, a high visitor score associated with the visitor may classify the visitor as a hot lead, whereas a low visitor score associated with the visitor may classify the visitor to be an average lead or a cold lead. In an embodiment, the processor 202 is configured to, with the content of the memory 204, cause the apparatus 200 to compare the visitor score with a threshold score. The threshold score is configured to serve as a cut-off value for visitor scores, and, visitor scores greater than or equal to the threshold score may be classified as high scores (or the corresponding visitor to be a hot lead). In an embodiment, an availability of the interaction invitation is determined upon determining the visitor score to be at least equal to (i.e. more than or equal to) the threshold score. In an illustrative example, the threshold score may be pre-determined (for example, based on empirical data) to be 65. If a visitor score of a visitor associated with the detection of the website access event is determined to be 60 (i.e. below the threshold score), then in example embodiment the determination of availability of the interaction invitation may be precluded for the visitor. In another illustrative example, the apparatus 200 may be configured to determine availability of interaction invitations for only a pre-determined number of visitors, such as for example, visitors associated with a top ten percentile visitor scores. In an embodiment, the apparatus 200 may preclude the comparison of the visitor score with the threshold score and determine availability of the interaction invitation for each visitor to the website.

In an embodiment, the processor 202 is configured to, with the content of the memory 204, cause the apparatus 200 to provide the interaction invitation to the visitor if the interaction invitation is determined to be available. The provisioning of the interaction invitations to the visitor may be performed in various ways. In an illustrative example, a chat widget may be displayed on each web page associated with the website. The chat widget may assume a pre-determined color, for example a green color from a preset red color, to indicate an availability of an active agent for interaction, thereby provisioning the interaction invitation to the visitor. In another example, a pop-up window may be displayed to the visitor on a current webpage of the website with a message, such as “Would you like to have a chat conversation with our agent?” for providing the interaction invitation. In yet another example, a button or an infographic including a message, such as “Would you like our agent to call you to discuss your requirements?” may be provided to the visitor for providing the interaction invitation. In an embodiment, the interaction invitation may be provided to the visitor as soon as an availability of the interaction invitation is determined. In an illustrative example, the visitor may not be offered the interaction invitation immediately upon detecting the website access event on the website, but may be provided the interaction invitation upon determining the visitor score to be greater than the threshold score based on the current web journey of the visitor on the website and determining an availability of the interaction invitation. The interaction invitation in such a case may be provided to the visitor on the webpage being currently viewed by the visitor.

In an embodiment, the processor 202 is configured to, with the content of the memory 204, cause the apparatus 200 to determine a priority order for providing the interaction invitation to the visitor upon determining the availability of the interaction invitation. In an embodiment, the priority order is determined upon detecting a presence of one or more other visitors with associated visitor scores at least equal to the threshold score. For example, upon determining a visitor score for a visitor (for example, a visitor ‘X’) to be at least equal to the threshold score and upon determining an availability of one or more interaction invitations, if a presence of one or more visitors (for example, visitors ‘Y’ and ‘Z’) with visitors scores at least equal to the threshold score are detected, then apparatus 200 is configured to determine a priority order of providing one or more interaction invitations to the visitors. In an embodiment, the priority order is determined based on a comparison of visitor scores associated with the visitors X, Y and Z. For example, a visitor with highest visitor score from among all the visitors X, Y and Z (i.e. a hot lead) may be placed at the highest level in the priority order. For example, if the visitor X is associated with a visitor score of 65 (indicating 65 percent probability of the visitor making a purchase in the current visit to the website) and the visitor Y is associated with a visitor score of 95 (indicating a 95 percent probability of the visitor making a purchase in the current visit to the website), then the visitor Y may be placed higher in the priority order for providing the one or more interaction invitations. In an example scenario, if only one interaction invitation is determined to be available, then the visitor Y may be provided with the interaction invitation.

In an embodiment, the priority order is determined based on predicted nature of assistance for the visitors. For example, if the predicted nature of assistance for visitor X corresponds to a visitor query that may be quickly resolved, whereas the predicted nature of assistance for a visitor Y corresponds to a payment or billing related issue indicative of higher time involvement for the active agent, then the visitor X may be placed higher in the priority order than visitor Y for providing the interaction assistance. In an embodiment, the predicted nature of assistance may also be indicative of a skill set desired in an active agent. For example, if one or more active agents associated with available interaction invitations are associated with skill set corresponding to providing assistance in resolving technical queries of the visitor, and, if predicted nature of assistance for a visitor is predicted to be a technical query, whereas one or more other visitors are predicted to seek billing dispute resolution, then the visitor may be placed higher in the priority order based on the matching skill set of the available active agents.

In an embodiment, the priority order of providing the interaction invitation is configured to facilitate interaction between an active agent associated with highest rating from among the active agents to a visitor with highest visitor score from among one of the visitor and the one or more other visitors. For example, the apparatus 200 is determined to configure the priority order in a manner that the visitor with the highest visitor score (i.e. hot lead) interacts with an active agent with the highest rating, or more specifically, an active agent with the highest probability of assisting the visitor successfully.

As explained above, a counter value indicative of a number of interaction invitations currently offered to one or more visitors is tracked by the apparatus 200. In an embodiment, the counter value (denoted by ‘Counter’) is incremented as depicted in equation (3) below upon providing the interaction invitation to the visitor:

Counter=Counter+1 (3)

In an embodiment, the processor 202 is configured to, with the content of the memory 204, cause the apparatus 200 to detect a visitor action event upon providing the interaction invitation to the visitor. The visitor action event corresponds to one of an invitation acceptance event and an invitation decline event. In an embodiment, the processor 202 is configured to, with the content of the memory 204, cause the apparatus 200 to detect an invitation ignore event upon a failure to receive the visitor action event corresponding to one of the invitation acceptance event and the invitation decline event within a pre-defined time threshold. In an embodiment, the pre-determined time threshold is configured based on at least one of an interaction medium associated with visitor, a day of a week associated with the interaction invitation and a time of the day associated with the interaction invitation. For example, the time threshold for an interaction invitation corresponding to a chat interaction may be pre-defined to be five seconds if a visitor device is a mobile phone, whereas the time threshold for an interaction invitation corresponding to a chat interaction may be pre-determined to be three seconds if a visitor device is on a computing device, such as a laptop or a desktop computer. In an embodiment, the time threshold may vary based on the day of the week and/or the time of the day. For example the time threshold may be configured to be of a longer duration during peak working hours of a weekday (for example, assuming that the visitor might be simultaneously involved in multiple tasks) than during evening/night hours or weekends. In an embodiment, the time threshold may be configured to be equal to the pre-determined average acceptance time.

In an embodiment, the counter value is updated upon detecting the visitor action event. In an embodiment, the visitor action event corresponds to one of an invitation acceptance event, an invitation decline event and an invitation ignore event. In an embodiment, the counter value is updated based on at least one of a first number of visitors from among the one or more visitors to have been offered interaction invitations to decline the interaction invitations and a second number of visitors from among the one or more visitors to ignore the interaction invitations. More specifically, if the first number of visitors to decline the interaction invitations is denoted by ‘V₁’ and the second number of visitors to ignore the interaction invitations is denoted by E(V₂), then the counter value denoted by ‘Counter’ may be determined as depicted in equation (4) below:

Counter=Counter−V₁−E(V₂) (4)

In an embodiment, the second number of visitors to ignore the interaction invitations (for example, V₁) is determined based on a pre-determined decay rate associated with each visitor from among the one or more visitors. In an embodiment, the decay rate may be pre-determined based on historical data associated with visitor interactions.

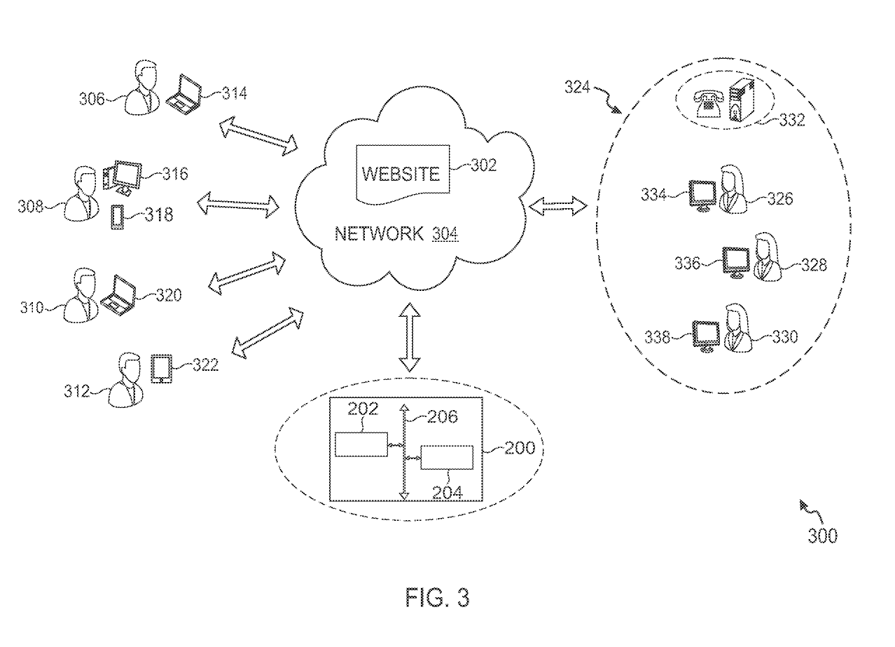

In an embodiment, the provisioning of interaction invitations to visitors upon determining an availability of interaction invitations facilitates a management of visitor interactions in an manner that substantially reduces, and in some cases eliminates, excessive wait time in queues for visitors to interact with agents. The visitors may thus receive assistance in a timely manner thereby enhancing a customer experience on the website. The provisioning of interaction invitations to a plurality of visitors is further explained with reference to an illustrative example in FIG. 3.

FIG. 3 is a schematic diagram 300 showing an example provisioning of interaction invitations to one or more visitors in accordance with an embodiment. The schematic diagram 300 depicts a plurality of online visitors of websites accessing a website 302 over a network 304. The plurality of online visitors is depicted to include visitors, such as a visitor 306, a visitor 308, a visitor 310 and a visitor 312 (hereinafter collectively referred to as visitors 306-312). It is understood the visitors 306-312 may visit the website 302 for reasons, such as to obtain product information, to receive purchase assistance, to make customer service queries and so forth. It is understood that the schematic diagram 300 is depicted to include four visitors for illustration purposes and that the website 302 may attract a plurality of visitors, such as the visitors 306-312, located at remote geographical locations. Each visitor from among the plurality of visitors is associated with one or more electronic devices for facilitating online access to the website 302. For example, customer 306 is associated with an electronic device 314, the visitor 308 is associated with electronic devices 316 and 318, the visitor 310 is associated with an electronic device 320 and the visitor 312 is associated with electronic device 322. The electronic devices 314, 316, 318, 320 and 322 are hereinafter collectively referred to as electronic devices 314-322. Examples of the electronic devices 314-322 may include personal computers, mobile phones, Smartphones, Smart watches, web-enabled pair of glasses, laptops, tablet computers, personal digital assistants and the like. It is understood that the website 302 is associated with a plurality of web pages and may be hosted on a web server on the network 304.

As explained above, visitors such as the visitors 306-312 may visit the websites, such as the website 302 to obtain product information, to receive purchase assistance, to make customer service queries and so forth. In order to provide assistance to the visitors, such as the visitors 306-312, an enterprise associated with the website 302 may maintain a customer sales and support (CSS) facility including a number of customer service representatives, such as agents, chat bots, self assist systems such as either web or mobile digital self-service and/or interactive voice response (IVR) systems. The schematic diagram 300 exemplarily depicts such a CSS facility 324 including a plurality of agents, such as agent 326, agent 328 and agent 330 and one or more self-assist mechanisms, such as an IVR system 332. It is understood that the CSS facility 324 may also include customer service representatives such as chat bots and self-assist systems. Moreover, it is noted that CSS facility 324 is depicted to include only three agents 326, 328 and 330 and the IVR system 332 for illustration purposes and it is understood that the CSS facility 324 may include fewer or more number of agents/IVR systems. Each agent in the CSS facility 324 is associated with one or more electronic devices. For example, the agent 326 is associated with electronic device 334, the agent 328 is associated with an electronic device 336, and the agent 330 is associated with electronic device 338. The agents 326, 328 and 330 (hereinafter collectively referred to as agents 326-330) may utilize the respective electronic devices for interacting with customers located at remote geographical locations, such as the visitors 306-312. It is noted that though the agents 326-330 are depicted to be associated with desktop computers in FIG. 1, the agents may also be associated with other electronic devices such as for example, telephone instruments, mobile phones, laptops and the like. The agents 326-330 and/or the IVR system 332 are capable of interacting with the visitors 306-312 to enable the visitors 306-312 achieve their intended purpose.

In an embodiment, the visitors 306-312 may seek to access the website 302 at substantially the same instance. Accordingly, the apparatus 200 depicted to be communicably associated with the website 302 may detect website access events corresponding to the visitors 306-312. As explained with reference to FIG. 2, the apparatus 200 is configured to compute a visitor score for each visitor upon detecting a website access event corresponding to the visitor. The visitor score for each visitor may be computed based on the pre-defined parameters as explained with reference to FIG. 2 and is not explained herein. In an illustrative example, the visitor scores associated with the visitors 306, 308, 310 and 312 may be 35, 60, 65 and 90, respectively. The apparatus 200 may further be configured to compare the visitor scores with a threshold score. In an illustrative example, the threshold score may be manually or dynamically chosen to be 50 based on empirical data. Accordingly, upon comparison, the apparatus 200 may determine the visitors 308, 310 and 312 to be associated with visitor scores above the threshold score implying a higher propensity to purchase product/service associated with the website (i.e. the visitors 308, 310 and 312 may be classified as hot leads).

Further as explained with reference to FIG. 2, the apparatus 200 may further be configured to determine availability of interaction invitations for offering assistance to the visitors 306-312. The apparatus 200 is configured to compute a maximum number of interaction invitations that may be offered to visitors of the website based on a number of active agents. In an illustrative example, the agents 326, 328 and 330 may considered to be active agents, or more specifically, agents currently available for conducting interactions (for example, voice or chat interaction) with the visitors. In an illustrative example, the interaction invitations may correspond to an invitation for a chat interaction and each agent from among the agents 326-330 may be capable of handling two visitor interactions concurrently. A maximum number of visitor interactions capable of being handled by the active agents may be computed using equation (1) as explained with reference to FIG. 2. Accordingly, it may be determined that a maximum of six visitor interactions (for example, three active agents each handling two visitor interactions) may be handled by the active agents. Furthermore, the apparatus 200 is configured to compute an acceptance rate as explained with reference to equation (2) in FIG. 2. In an illustrative example, the acceptance rate may be determined to be 0.5. Accordingly, the maximum number of interaction invitations may be determined based on equation (3) as explained with reference to FIG. 2. More specifically, the maximum number of interaction invitations may be determined to be 12 (for example, 6/0.5). The apparatus 200 is configured to determine an availability of interaction invitation from among 12 interaction invitations computed to be offered to the visitors.

As explained with reference to FIG. 2, the apparatus 200 may determine a counter value indicative of the number of interaction invitations currently offered to visitors. In an illustrative example, the counter value may be nine indicating that nine interaction invitations are currently offered to visitors. The apparatus 200 may be configured to compare the counter value with the maximum number of interaction invitations and determine an availability of the interaction invitation if the counter value is less than the maximum number of interaction invitations. In the illustrative example, the counter value of nine is less than the maximum number of interaction invitations computed to be 12. In an embodiment, the apparatus 200 may prioritize the visitors from among the visitors 306-312 based on visitor scores (as explained with reference to FIG. 2) and provide the interaction invitations to the visitors with higher propensity to buy. Accordingly visitors 312, 310 and 308 may be offered interaction invitation in the respective order. It is understood that a determination of the priority order for providing the interaction invitations may be not limited to the visitor scores and other factors, such as the predicted nature of assistance, the skill set of available active agents and the like, may be taken into consideration for determining the priority order as explained with reference to FIG. 2. After each provisioning of an interaction invitation a counter value may be incremented by one. Accordingly, subsequent to providing the interaction invitation to the visitor 308, the counter value may be equal to 12. The counter value may then be equal to the maximum number of interaction invitations and accordingly, an interaction invitation may be unavailable for provisioning assistance to the visitor 306. In an embodiment, only those visitors with visitor scores above the threshold score may be considered for provisioning interaction invitation. In an embodiment, if no other visitor with visitor score above the threshold score is determined to be present, and, if interaction invitations are determined to be available, then the visitor with higher visitor scores from among the remaining visitors may be offered interaction invitations.

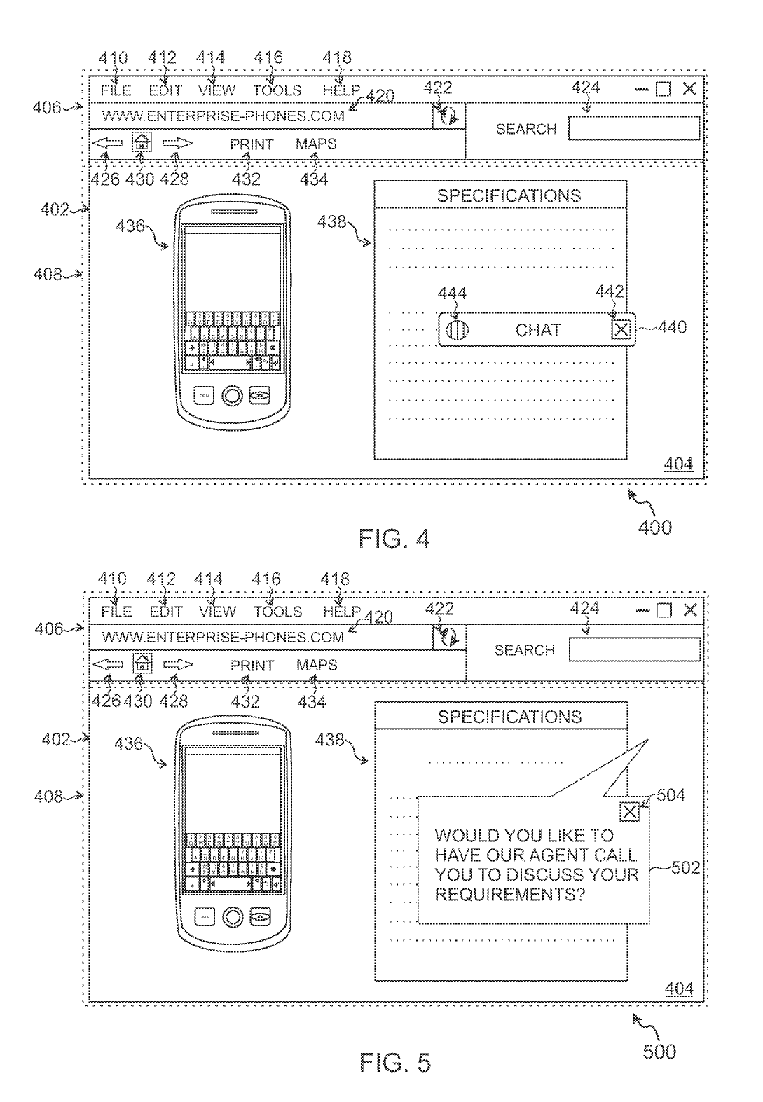

Subsequent to provisioning of the interaction invitations, apparatus 200 may be configured to detect a visitor action event from among an invitation acceptance event and an invitation decline event and update the counter value as explained with reference to equation (4) in FIG. 2. An example provisioning of the interaction invitation is illustrated in FIGS. 4 and 5.

FIG. 4 is a first example screenshot 400 of a visitor device screen showing an example interaction invitation to a visitor in accordance with an embodiment. The first example screenshot (hereinafter referred to as screenshot 400) depicts a web browser 402 associated with the visitor's electronic device. Examples of the web browser 402 may include, but are not limited to popular web browsers, such as Internet Explorer® web browser, Safari® web browser, Chrome™ web browser and Mozilla® web browser or even proprietary web browsers. The web browser 402 is configured to display a web page 404 corresponding to a website that the visitor has visited.

The web browser 402 includes a menu section 406 and webpage display section 408. The menu section 406 displays standard menu options such as “File 410”, “Edit 412”, “View 414”, “Tools 416” and “Help 418”. It is noted that the menu options are depicted for example purposes and that the menu section 406 may include fewer or more number of menu options than those displayed in FIG. 4. Further, each menu option may be configured to display upon clicking, a drop down list of secondary menu options. For example, upon clicking on the “File 410” menu option, a drop down list of secondary menu options (not shown in FIG. 4) such as “New Window”, “New Tab”, “Open location”, “Save As” and the like may be displayed. Each of the secondary menu options may be associated with an intended functionality. For example, the “New Window” secondary menu option may facilitate an opening of a new browser window. Similarly, the “Save As” secondary menu option may facilitate saving of the UI on display in one of various formats, such as for example a hyper text markup language (HTML) format or a text format. Each of the menu options such as “Edit 412”, “View 414”, “Tools 416” and “Help 418” may similarly include secondary menu options with associated functionalities.

The menu section 406 is further depicted to include a text box configured to receive user input in form of a web link, such as web link 420 (for example, web link is exemplarily depicted as WWW.ENTERPRISE-PHONES.COM). The web link 420 may trigger a hypertext transfer protocol (HTTP) request to fetch a desired webpage, such as the webpage 404, corresponding to a website from over the network, such as network 104 explained with reference to FIG. 1. It is noted that the fetching of the webpage may involve standard procedures such as domain name resolutions using a domain name server (DNS) server and the like and are not discussed herein. The text box may further include a refresh icon 422 for re-sending the HTTP request for re-fetching the web page corresponding to the web application.

The menu section 406 further includes a search bar text box 424 (also referred to herein as search box 424) configured to receive user input in form of a search request. In an embodiment, the search box 424 may be associated with one or more search engines, such as Google search engine, Yahoo search engine and/or Baidu search engine. Upon receiving user input in form of text for searching on the Internet, a webpage including results of the search may be displayed to the user. Further, the menu section 406 includes a plurality of icons, such as icons 426, 428, 430, 432 and 434 providing quick access to a previously accessed webpage, a subsequently accessed page, a home page and a print page feature and a map feature, respectively.

The webpage display section 408 is configured to display web pages corresponding to the accessed website URLs. For example, the web page 404 is displayed upon accessing the URL “WWW.ENTERPRISE-PHONES.COM”. The webpage 404 is depicted to display example image content 436 corresponding to a mobile phone along with corresponding textual content 438 related to the mobile phone specifications. The visitor may access the web page 404 with an intent of seeking information about the mobile phones sold by an enterprise associated with the URL “WWW.ENTERPRISE-PHONES.COM”. As explained with reference to FIGS. 2 and 3, the enterprise may offer assistance to visitors to the website in form of interactions with active agents (and/or IVR systems). The apparatus 200 explained with reference to FIG. 2 may determine if an interaction invitation can be provisioned to the visitor based on the visitor score and the availability of interaction invitations. Upon determining that the interaction invitation may be provided to the visitor on the website, a chat widget 440 may appear on the web page 404. The visitor may initiate a chat interaction with an active agent by clicking the chat widget 440. Alternatively, the visitor may decline the interaction invitation may clicking on ‘close’ icon 442 on the chat widget 440. The visitor may also choose to ignore the interaction invitation. In an embodiment, the apparatus 200 may be configured to preclude display of the chat widget 440 on the web page 404 if an invitation ignore event is detected by the apparatus 200 as explained with reference to FIG. 2. More specifically, the apparatus 200 may detect the invitation ignore event upon detecting an elapsing of a pre-defined time threshold and accordingly remove the display of the chat widget 440 from the web page 404. It is understood the provisioning of the chat widget 440 on the web page 404 is explained herein for example purposes and it is noted that various such techniques may be employed for providing the interaction invitation to the visitor. For example, the chat widget 440 may be configured to be a static feature on each web page associated with the website. The chat widget 440 may include a button, such as a button 444, which may assume a pre-determined color, for example a green color from a preset red color, to indicate an availability of an active agent for interaction, thereby provisioning the interaction invitation to the visitor. Another example provisioning of an interaction invitation to a visitor is explained with reference to FIG. 5.

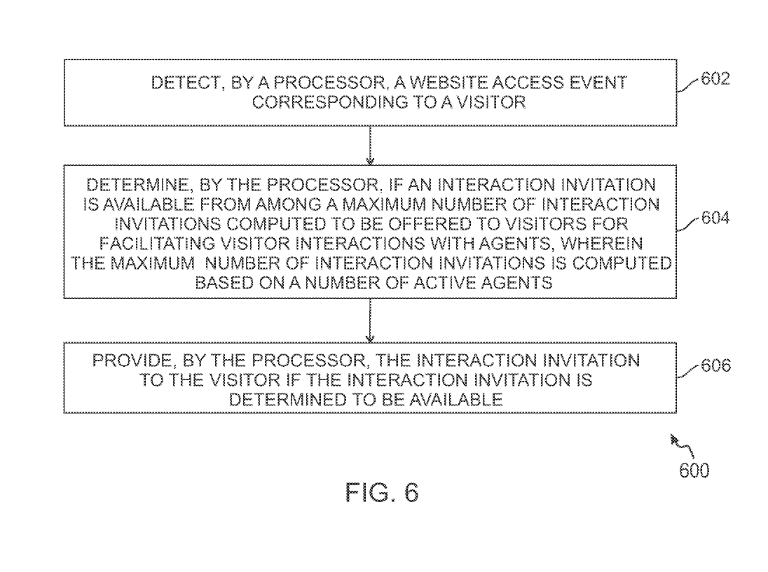

FIG. 5 is a second example screenshot 500 of a visitor device screen showing an example interaction invitation provided to a visitor in accordance with another embodiment. The screenshot 500 depicts the web browser 402 associated with the visitor's electronic device. The web browser 402 and the various components of the web browser 402, such as the components 406-434 are explained with reference to FIG. 4 and are not explained herein for sake of brevity. For illustration purposes, the web browser 402 is configured to display the web page 404 corresponding to the URL “WWW.ENTERPRISE-PHONES.COM”. Upon determining that the interaction invitation may be provided to the visitor on the website, a pop-up window 502 may appear on the web page 404. The pop-up window 502 may include text, such as ‘Would you like our agent to contact you to discuss your requirements?’ to facilitate provisioning of the interaction invitation (for example, a voice interaction) to the visitor. The visitor may choose to provide his/her acceptance by clicking on the pop-up window 502. Alternatively, the visitor may decline the interaction invitation may clicking on ‘close’ icon 504 on the pop-up window 502. The visitor may also choose to ignore the interaction invitation. In an embodiment, the apparatus 200 may be configured to preclude display of the pop-up window 502 on the web page 404 if a invitation ignore event is detected by the apparatus 200 as explained with reference to FIG. 2. Upon detecting one of the invitation acceptance event, the invitation decline event and the invitation ignore event, the apparatus 200 may be configured to update a counter value as explained with reference to FIG. 2. The updated counter value may facilitate in determination of availability of interaction invitations for subsequent visitors to the website, thereby enabling a managing of visitor interactions in an efficient manner. A method for managing visitor interactions is explained with reference to FIG. 6.

FIG. 6 is a flow diagram of a first example method 600 for managing visitor interactions in accordance with an embodiment. The first example method 600 (hereinafter referred to as method 600) depicted in the flow diagram may be executed by, for example, the apparatus 200 explained with reference to FIGS. 2-5. Operations of the flowchart, and combinations of operation in the flowchart, may be implemented by, for example, hardware, firmware, a processor, circuitry and/or a different device associated with the execution of software that includes one or more computer program instructions. The operations of the method 600 are described herein with help of the apparatus 200. For example, one or more operations corresponding to the method 600 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 600 can be described and/or practiced by using a system other than the apparatus 200. The method 600 starts at operation 602.

At operation 602, a website access event corresponding to a visitor is detected by the processor. In an illustrative example, one or more tracking cookies may be linked to the website. A website access event by the visitor may trigger a downloading of the one or more tracking cookies into a web browser storage associated with the visitor device, thereby facilitating detection of the website access event by the visitor. It is noted that such an example of detection of the website access event is included herein for illustration purposes and one or more such standard techniques may be employed for detection of the website access event by the visitor. For example, a uniform resource locator (URL) based connection request at a web server hosting the website by the visitor may be tracked for detecting the website access event.

At operation 604, an availability of an interaction invitation from among a maximum number of interaction invitations is determined by the processor. In an embodiment, the maximum number of interaction invitations to be offered to visitors for facilitating visitor interactions with agents is computed based on a number of active agents. As explained with reference to FIG. 1, some websites may offer assistance to visitors visiting the website in form of interaction with customer service representatives or agents. The offer for assistance may be embodied in form of an interaction invitation. In an embodiment, the interaction invitation corresponds to an invitation for facilitating one of a chat interaction and a voice interaction with an active agent. The term ‘active agent’ refers to an agent, who is currently available for handling an interaction with a visitor.

In an embodiment, a maximum number of visitor interactions capable of being handled by one or more active agents associated with the number of active agents at any given point of time is determined. In some cases, the one or more active agents are capable of interacting concurrently with two or more visitors. For example, if a nature of interaction is chosen to be a chat interaction, then each active agent may concurrently chat with one or more visitors. Accordingly, the maximum number of interaction invitations may be computed based on a number of concurrent visitor interactions capable of being handled by the active agents. For example, if a number of active agents is five and each of the five active agents can handle five chat interactions with visitors, then the maximum number of visitor interactions may be determined to be 25 (for example, five active agents with each active agent handling five interactions). In another embodiment, if a nature of interaction is chosen to be a voice interaction, then each active agent may interact with only visitor at given time (i.e. concurrency is one). Accordingly, the maximum number of interaction invitations may be computed based on a number of active agents. For example, if a number of active agents is five, then the maximum number of visitor interactions may be determined to be five. In an embodiment, a pre-determined average acceptance time and a pre-determined average wait time associated with visitor interactions may be taken into account while determining the maximum number of visitor interactions as explained with reference to FIG. 2.

In an embodiment, an acceptance rate indicative of a rate of acceptance of one or more interaction invitations offered to the visitors is determined by the processor. The acceptance rate may be determined based on equation (1) as explained with reference to FIG. 2. In an embodiment, the maximum number of interaction invitations is computed based on the maximum number of visitor interactions and the acceptance rate. The maximum number of interaction invitations may be computed as explained with reference to equation (2) in FIG. 2. For example, if maximum number of visitor invitations capable of being handled by the number of active agents is ten and the acceptance rate is 0.5, then maximum number of interaction invitations that may be offered to visitors may be computed to be 10/0.5 or 20.

In an embodiment, a counter value indicative of a number of interaction invitations currently offered to one or more visitors may be determined by the processor. More specifically, a number of interaction invitations that are being offered to visitors as well as a status of those interaction invitations (for example, one of an accepted, declined or ignored status) is continuously tracked. Upon detecting the website access event, a comparison of the counter value with the maximum number of interaction invitations is performed. If the counter value is less than the maximum number of interaction invitations, then an interaction invitation is determined to be available for facilitating interaction between the visitor and an active agent. However if the counter value is at least equal to the maximum number of interaction invitations, then the interaction invitation is determined to be unavailable and the interaction invitation is not extended to the visitor.

At operation 606, the interaction invitation is provided to the visitor by the processor if the interaction invitation is determined to be available. The provisioning of the interaction invitations to the visitor may be performed in various ways as depicted in FIGS. 4 and 5. In an embodiment, the interaction invitation may be provided to the visitor as soon as an availability of the interaction invitation is determined. In an illustrative example, the visitor may not be offered the interaction invitation immediately upon detecting the website access event on the website, but may be provided the interaction invitation upon determining the visitor score to be greater than the threshold score based on the current web journey of the visitor on the website and determining an availability of the interaction invitation. The interaction invitation in such a case may be provided to the visitor on the webpage being currently viewed by the visitor.

In an embodiment, a priority order for providing the interaction invitation to the visitor may be determined by the processor upon determining the availability of the interaction invitation. In an embodiment, the priority order is determined upon detecting a presence of one or more other visitors with associated visitor scores at least equal to the threshold score. For example, upon determining a visitor score for a visitor (for example, a visitor ‘X’) to be at least equal to the threshold score and upon determining an availability of one or more interaction invitations, if a presence of one or more visitors (for example, visitors ‘Y’ and ‘Z’) with visitors scores at least equal to the threshold score are detected, then processor may determine the priority order of providing one or more interaction invitations to the visitors. In an embodiment, the priority order may be determined based on a comparison of visitor scores associated with the visitors X, Y and Z. For example, a visitor with highest visitor score from among all the visitors X, Y and Z (i.e. a hot lead) may be placed at the highest level in the priority order. For example, if the visitor X is associated with a visitor score of 65 and the visitor Y is associated with a visitor score of 95, then the visitor Y may be placed higher in the priority order for providing the one or more interaction invitations. In an example scenario, if only one interaction invitation is determined to be available, then the visitor Y may be provided with the interaction invitation.

In an embodiment, the priority order is determined based on predicted nature of assistance for the visitors. For example, if the predicted nature of assistance for visitor X corresponds to a visitor query that may be quickly resolved, whereas the predicted nature of assistance for a visitor Y corresponds to a payment or billing related issue indicative of higher time involvement for the active agent, then the visitor X may be placed higher in the priority order than visitor Y for providing the interaction assistance. In an embodiment, the predicted nature of assistance may also be indicative of a skill set desired in an active agent. For example, if one or more active agents associated with available interaction invitations are associated with skill set corresponding to providing assistance in resolving technical queries of the visitor, and, if predicted nature of assistance for a visitor is predicted to be a technical query, whereas one or more other visitors are predicted to seek billing dispute resolution, then the visitor may be placed higher in the priority order based on the matching skill set of the available active agents.

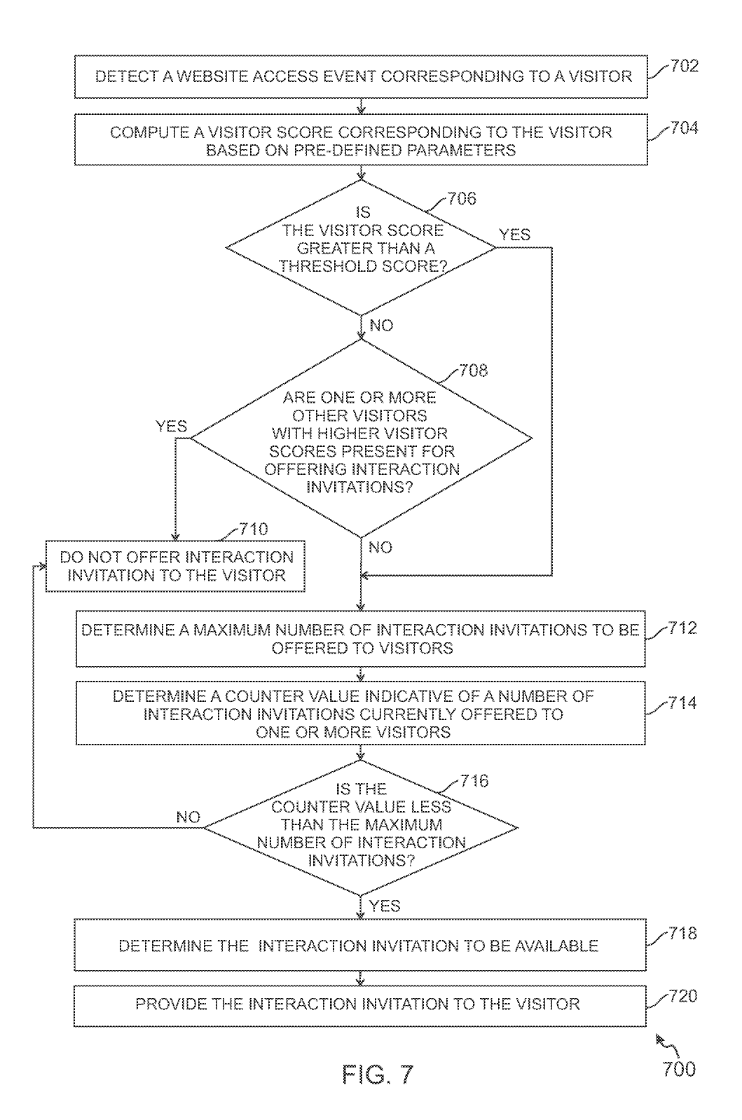

In an embodiment, the priority order of providing the interaction invitation is configured to facilitate interaction between an active agent associated with highest rating from among the active agents to a visitor with highest visitor score from among one of the visitor and the one or more other visitors. For example, the apparatus 200 is determined to configure the priority order in a manner that the visitor with the highest visitor score (i.e. hot lead) interacts with an active agent with the highest rating, or more specifically, an active agent with the highest probability of assisting the visitor successfully. Another method for managing visitor interactions is explained with reference to FIG. 7.

FIG. 7 is a flow diagram depicting a second example method 700 for managing visitor interactions in accordance with an embodiment. The second example method 700 (hereinafter referred to as method 700) depicted in the flow diagram may be executed by, for example, the apparatus 200 explained with reference to FIGS. 2-5. Operations of the flowchart, and combinations of operation in the flowchart, may be implemented by, for example, hardware, firmware, a processor, circuitry and/or a different device associated with the execution of software that includes one or more computer program instructions. The operations of the method 700 are described herein with help of the apparatus 200. For example, one or more operations corresponding to the method 700 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 700 can be described and/or practiced by using a system other than the apparatus 200. The method 700 starts at operation 702.

At operation 702, a website access event corresponding to a visitor is determined, for example by the processor. The determination of the website access event may be performed as explained with reference to operation 602 of the method 600 and is not explained herein. At operation 704, a visitor score corresponding to the visitor is computed (for example by the processor) based on pre-defined parameters. In an embodiment, the pre-defined parameters correspond to at least one of a predicted visitor's interest in availing at least one of a product and a service associated with the website, a past purchasing history associated with the visitor, a web journey associated with the visitor, a visitor profile information and time spent on one or more web pages associated with the website by the visitor.

In an embodiment, information stored related to the visitors may be stored (for example, in the memory 204 of the apparatus 200). The stored information related to the visitors may include, but is not limited to, visitor profile information, information related to visitor interests and preferences, recent transactions, past interaction with agents, website surfing patterns and the like. The stored information corresponding to the visitors may be subjected to a set of text mining & predictive models (hereinafter collectively referred to as prediction models) for mining relevant information that drive the prediction of the visitor intent (for example, by a prediction engine associated with the apparatus 200). Examples of the prediction models may include, but are not limited to Logistic regression, Naïve Bayesian, Rule Engines, Neural Networks, Decision Trees, Support Vector Machines, k-nearest neighbor, K-means and the like. The prediction models may be configured to extract certain features from past visitor interactions or from the agent interactions or from both visitor and agent interactions. Further, the prediction models may be configured to extract features by utilizing a relationship between the visitor and agent interactions (for example, sentiment of the visitor for a given agent response). Examples of the features that may be fed into the prediction models may include, but are not limited to, any combinations of words features such as n-grams, unigrams, bigrams and trigrams, word phrases, part-of-speech of words, sentiment of words, sentiment of sentences, position of words, customer keyword searches, visitor click data, visitor web journeys, the visitor interaction history and the like. In an embodiment, the prediction models may utilize any combination of the above-mentioned input features along with the visitor interaction data such as, but not limited to, which agent handled the dialogue, what the outcome was, interaction transfers if any and the like to predict the visitor's likely intents. The mined information enables the prediction engine to infer intent of a visitor for being present on the website.

In an embodiment, the stored information corresponding to the visitor associated with the website access event, such as a past purchasing history associated with the visitor, a web journey associated with the visitor, a visitor profile information and time spent on one or more web pages associated with the website by the visitor and the like is retrieved. In an embodiment, the retrieved information along with the received information such as the predicted intent of the visitor in availing at least one of a product and a service associated with the website from the prediction engine are included in a scoring model as parameters and assigned appropriate weights to each parameter, by the processor, to generate a visitor score. For example, a higher weight may be assigned to web page related to payments on the website. Accordingly a visitors' web journey on the website involving a visit to the web page related to payments may be assigned a higher weight and accordingly may contribute to a higher visitor score. Similarly, if the visitor has visited the website subsequent to visiting a web page for another website related to best deals on a product or a service, then higher weight may be assigned to such a web journey associated with the visitor, as such a web journey may be indicative of higher propensity of the visitor to make a purchase on the website. It is understood that various combinations of factors may be utilized for assigning weights to various parameters for generating the visitor score and the generation of visitor score may not be limited to examples provided herein.

As explained above, the visitor score indicates if the visitor is a ‘hot lead’ or not, or in other words, how likely is the visitor to make a purchase in the current visit to the website. In an embodiment, the visitor score is computed to be a probabilistic number indicative of the visitor's propensity to make a purchase or avail a service. For example, a visitor score of 70 may indicate a 70 percent probability of the visitor making a purchase in the current visit to the website. Accordingly, a high visitor score associated with the visitor may classify the visitor as a hot lead, whereas a low visitor score associated with the visitor may classify the visitor to be an average lead or a cold lead.

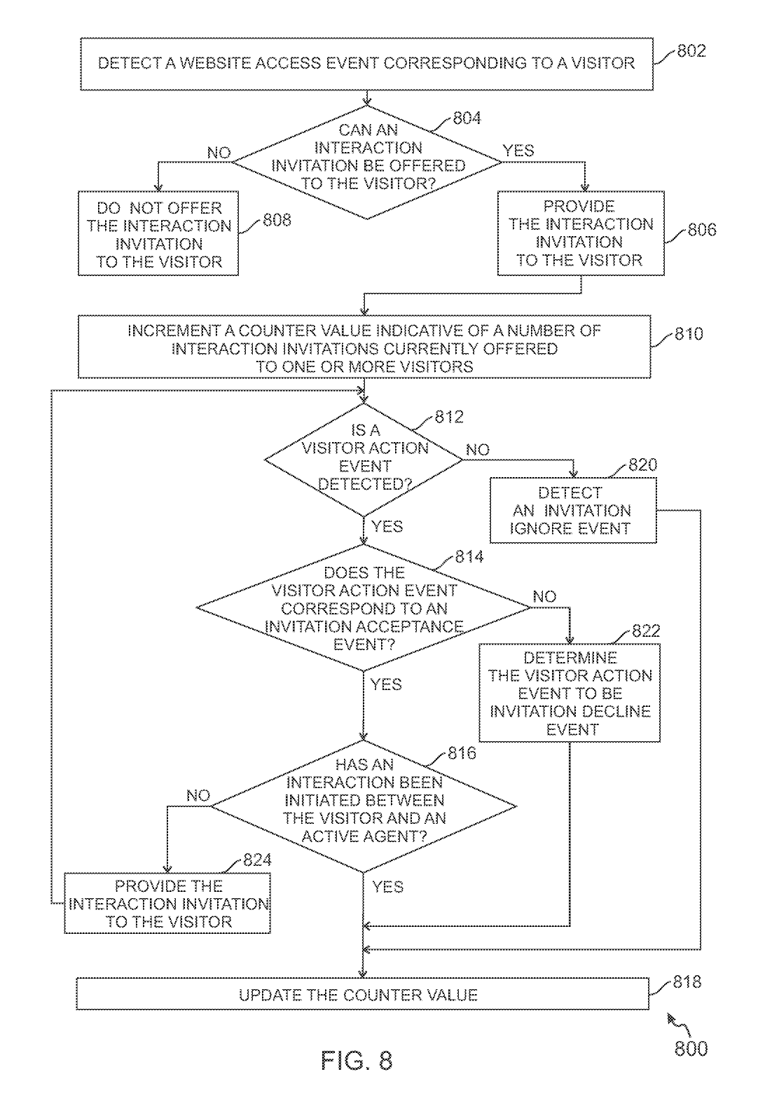

At operation 706, the visitor score is compared with a threshold score by the processor. More specifically, at operation 706, it is checked whether the visitor score is greater than the threshold score. The threshold score is configured to serve as a cut-off value for visitor scores, and, visitor scores greater than or equal to the threshold score may be classified as high scores (or the corresponding visitor to be a hot lead). If the visitor score is greater than the threshold score, then at operation 708 a presence of one or more other visitors with higher visitor scores than the visitor and which may be offered interaction invitations is checked. If it is determined that one or more visitors with higher visitor scores and who may be offered interaction invitations are present, then at operation 710, it is determined to not offer interaction invitation to the visitor. If at operation 706, it is determined that the visitor score is greater than the threshold score, or, if at operation 708, if it is determined that no other visitor with higher visitor score and who may be offered interaction invitation is present, then at operation 712, a maximum number of interaction invitations to be offered to visitors on the website is determined by the processor. At operation 714, a counter value indicative of a number of interaction invitations currently offered to visitors is determined by the processor. At operation 716, it is determined if the counter value is less than the maximum number of interaction invitations by the processor. At operation 718, an availability of interaction invitations is determined if the counter value is determined to be less than the maximum number of interaction invitations at operation 716. If the interaction invitation is determined to be not available at operation 716, then at operation 710, it is determined to not offer interaction invitation to the visitor. The determination of the availability of the interaction invitation from operations 708, 710, 712, 714, 716 and 718 may be performed as explained with reference to operation 604 in the method 600 of FIG. 6 and is not explained herein for sake of brevity. At operation 720, the interaction invitation is provided to the visitor. The provisioning of the interaction invitation to the visitor may be performed as explained with reference to operation 606 of the method 600 of FIG. 6 and is not explained herein. Another method for managing visitor interactions is explained with reference to FIG. 8.

FIG. 8 is a flow diagram depicting a third example method 800 for managing visitor interactions in accordance with an embodiment. The third example method 800 (hereinafter referred to as method 800) depicted in the flow diagram may be executed by, for example, the apparatus 200 explained with reference to FIGS. 2-5. Operations of the flowchart, and combinations of operation in the flowchart, may be implemented by, for example, hardware, firmware, a processor, circuitry and/or a different device associated with the execution of software that includes one or more computer program instructions. The operations of the method 800 are described herein with help of the apparatus 200. For example, one or more operations corresponding to the method 700 are explained herein to be executed by a processor, such as the processor 202 of the apparatus 200. It is noted that though the one or more operations are explained herein to be executed by the processor alone, it is understood that the processor is associated with a memory, such as the memory 204 of the apparatus 200, which is configured to store machine executable instructions for facilitating the execution of the one or more operations. It is also noted that, the operations of the method 800 can be described and/or practiced by using a system other than the apparatus 200. The method 800 starts at operation 802.

At operation 802, a website access event corresponding to a visitor is determined for example by the processor. The determination of the website access event may be performed as explained with reference to operation 602 of the method 600 and is not explained herein. At operation 804, it is determined if an interaction invitation can be offered to the visitor by the processor. The determination may be performed based on the visitor score and the determined availability of an interaction invitation. The computation of the visitor score and determination of the availability of the interaction invitation may be performed as explained with reference to operations 704 to 720 and is not explained herein. If it is determined that the interaction invitation can be offered to the visitor, then at operation 806, the interaction invitation is provided to the visitor. The provisioning of the interaction invitation to the visitor may be performed as explained with reference to operation 606 of the method 600 of FIG. 6 and is not explained herein. If it determined that the interaction invitation cannot be offered to the visitor, then offering of the interaction invitation to the visitor is precluded at operation 808.

At operation 810, a counter value indicative of a number of interaction invitations currently offered to one or more visitors is incremented. The counter value may be incremented as explained with reference to equation (3) in FIG. 2. At operation 812, it is checked if a visitor action event is detected. If the visitor action event is detected, then at operation 814, it is determined if the visitor action event corresponds to invitation acceptance event. If it is determined that the visitor action event corresponds to the invitation acceptance event, then at operation 816, it is determined if the interaction between the visitor and the active agent is initiated. If it is determined that the interaction between the visitor and the active agent is initiated at operation 816, then at operation 818, a counter value is updated. In an embodiment, the counter value is updated based on at least one of a first number of visitors to decline the interaction invitations and a second number of visitors to ignore the interaction invitations. The counter value may be updated based on equation (4) as explained with reference to FIG. 2. In an embodiment, the second number of visitors to ignore the interaction invitations (for example, V₁) is determined based on a pre-determined decay rate associated with each visitor from among visitors associated with the number of visitors. In an embodiment, the decay rate may be pre-determined based on historical data associated with visitor interactions.

If the visitor action event is not detected at operation 812, then an invitation ignore event is determined at operation 820 and the counter value is updated at operation 818. If the visitor action event is detected not to be the invitation acceptance event, then the visitor action event is determined to the invitation decline event at operation 822 and the counter value is updated at operation 818. If at operation 816, it is determined that the interaction is not initiated between the visitor and the active agent, then the interaction invitation is again provided to the visitor at operation 824 and the operations 812 to 816 are repeatedly performed till the interaction is initiated between the visitor and the active agent.

Without in any way limiting the scope, interpretation, or application of the claims appearing below, advantages of one or more of the exemplary embodiments disclosed herein include the provisioning of interaction invitations to visitors upon determining an availability of interaction invitations. Such a provisioning of interaction invitation ensures that a number of interaction invitations offered for chat interaction or voice interaction is less than the number of active agents, thereby substantially reducing, and in some cases eliminating, excessive wait time in queues for visitors to interact with agents. As a result, an abandonment of queues is reduced to a substantial extent. Moreover, such a management of visitor interactions enables prioritizing a provisioning of interaction invitations to visitors with propensity to purchase products/services, thus enabling the enterprise to cater to existing/potential customers in an efficient manner. Furthermore, the interaction invitations are detected to be ignored in a timely manner and appropriate measures are taken into account to offer the ignored interaction invitations to other visitors who may need assistance. The visitors may thus receive assistance in a timely manner thereby enhancing a customer experience on the website.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method comprising:
detecting, by a processor, a website access event corresponding to a visitor;
determining by the processor, upon detecting the website access event, if an interaction invitation is available from among a maximum number of interaction invitations computed to be offered to visitors for facilitating visitor interactions with agents, the maximum number of interaction invitations computed based on a number of active agents; and
providing, by the processor, the interaction invitation to the visitor if the interaction invitation is determined to be available.

2. The method of claim 1, wherein the interaction invitation corresponds to an invitation for facilitating one of a chat interaction and a voice interaction with an active agent from among active agents associated with the number of active agents.

3. The method of claim 2, further comprising:
computing, by the processor, a visitor score corresponding to the visitor upon detecting the website access event, the visitor score computed based on pre-defined parameters; and
comparing, by the processor, the visitor score with a threshold score, wherein an availability of the interaction invitation is determined upon determining the visitor score to be at least equal to the threshold score.

4. The method of claim 3, further comprising:
determining a priority order for providing the interaction invitation to the visitor upon determining the availability of the interaction invitation, wherein the priority order is determined upon detecting a presence of one or more other visitors with associated visitor scores at least equal to the threshold score.

5. The method of claim 4, wherein the priority order is determined based on a comparison of the visitor score with the visitor scores associated with the one or more other visitors.

6. The method of claim 4, wherein the priority order is determined based on predicted nature of assistance for the visitor and the one or more other visitors.

7. The method of claim 4, wherein the priority order of providing the interaction invitation is configured to facilitate interaction between an active agent associated with highest rating from among the active agents to a visitor with highest visitor score from among one of the visitor and the one or more other visitors.

8. The method of claim 3, wherein the pre-defined parameters correspond to at least one of a predicted visitor's interest in availing at least one of a product and a service associated with a website corresponding to the website access event, a past purchasing history associated with the visitor, a web journey associated with the visitor, a visitor profile information and time spent on one or more web pages associated with the website by the visitor.

9. The method of claim 1, further comprising:
determining, by the processor, a maximum number of visitor interactions capable of being handled by one or more active agents associated with the number of active agents; and
determining, by the processor, an acceptance rate indicative of a rate of acceptance of one or more previously offered interaction invitations, wherein the maximum number of interaction invitations is computed based on the maximum number of visitor interactions and the acceptance rate.

10. The method of claim 9, wherein the one or more active agents are capable of interacting concurrently with two or more visitors.

11. The method of claim 9, wherein the maximum number of visitor interactions is determined based on a pre-determined average acceptance time and a pre-determined average wait time associated with the visitor interactions.

12. The method of claim 9, further comprising:
determining, by the processor, a counter value indicative of a number of interaction invitations currently offered to one or more visitors; and
comparing, by the processor, the counter value with the maximum number of interaction invitations, wherein the interaction invitation is determined to be available if the counter value is less than the maximum number of interaction invitations.

13. The method of claim 12, wherein the counter value is incremented, by the processor, by one upon providing the interaction invitation to the visitor.

14. The method of claim 12, further comprising detecting, by the processor, a visitor action event upon providing the interaction invitation to the visitor, wherein the visitor action event corresponds to one of an invitation acceptance event and an invitation decline event.

15. The method of claim 14, further comprising detecting, by the processor, an invitation ignore event upon a failure to receive the visitor action event corresponding to one of the invitation acceptance event and the invitation decline event within a pre-defined time threshold.

16. The method of claim 15, wherein the pre-defined time threshold is configured based on at least one of an interaction medium associated with the visitor, a day of a week associated with the interaction invitation and a time of the day associated with the interaction invitation.

17. The method of claim 15, wherein the counter value is updated, by the processor, upon detecting one of the invitation acceptance event, the invitation decline event and the invitation ignore event.

18. The method of claim 17, wherein the counter value is updated based on at least one of a first number of visitors from among the one or more visitors to decline the interaction invitations and a second number of visitors from among the one or more visitors to ignore the interaction invitations.

19. The method of claim 18, wherein the second number of visitors to ignore the interaction invitations is determined based on a pre-determined decay rate associated with each visitor from among the one or more visitors.

20. An apparatus comprising:
at least one processor; and
a memory having stored therein machine executable instructions, that when executed by the at least one processor, cause the apparatus to:
detect a website access event corresponding to a visitor;
determine, upon detecting the website access event, if an interaction invitation is available from among a maximum number of interaction invitations computed to be offered to visitors for facilitating visitor interactions with agents, the maximum number of interaction invitations computed based on a number of active agents; and
provide the interaction invitation to the visitor if the interaction invitation is determined to be available.

21. The apparatus of claim 20, wherein the interaction invitation corresponds to an invitation for facilitating one of a chat interaction and a voice interaction with an active agent from among active agents associated with the number of active agents.

22. The apparatus of claim 21, wherein the apparatus is further caused to:
compute a visitor score corresponding to the visitor upon detecting the website access event, the visitor score computed based on pre-defined parameters; and
compare the visitor score with a threshold score, wherein an availability of the interaction invitation is determined upon determining the visitor score to be at least equal to the threshold score.

23. The apparatus of claim 22, wherein the apparatus is further caused to:
determine a priority order for providing the interaction invitation to the visitor upon determining the availability of the interaction invitation, wherein the priority order is determined upon detecting a presence of one or more other visitors with associated visitor scores at least equal to the threshold score.

24. The apparatus of claim 23, wherein the priority order is determined based on a comparison of the visitor score with the visitor scores associated with the one or more other visitors.

25. The apparatus of claim 23, wherein the priority order is determined based on predicted nature of assistance for the visitor and the one or more other visitors.

26. The apparatus of claim 23, wherein the priority order of providing the interaction invitation is configured to facilitate interaction between an active agent associated with highest rating from among the active agents to a visitor with highest visitor score from among one of the visitor and the one or more other visitors.

27. The apparatus of claim 22, wherein the pre-defined parameters correspond to at least one of a predicted visitor's interest in availing at least one of a product and a service associated with a website corresponding to the website access event, a past purchasing history associated with the visitor, a web journey associated with the visitor, a visitor profile information and time spent on one or more web pages associated with the website by the visitor.

28. The apparatus of claim 20, wherein the apparatus is further caused to:
determine a maximum number of visitor interactions capable of being handled by one or more active agents associated with the number of active agents; and
determine an acceptance rate indicative of a rate of acceptance of one or more previously offered interaction invitations, wherein the maximum number of interaction invitations is computed based on the maximum number of visitor interactions and the acceptance rate.

29. The apparatus of claim 28, wherein the apparatus is further caused to:
determine a counter value indicative of a number of interaction invitations currently offered to one or more visitors; and
compare the counter value with the maximum number of interaction invitations, wherein the interaction invitation is determined to be available if the counter value is less than the maximum number of interaction invitations.

30. The apparatus of claim 29, wherein the apparatus is further caused to increment the counter value by one upon providing the interaction invitation to the visitor.

31. The apparatus of claim 29, wherein the apparatus is further caused to detect a visitor action event upon providing the interaction invitation to the visitor, wherein the visitor action event corresponds to one of an invitation acceptance event and an invitation decline event.

32. The apparatus of claim 31, wherein the apparatus is further caused to detect an invitation ignore event upon a failure to receive the visitor action event corresponding to one of the invitation acceptance event and the invitation decline event within a pre-defined time threshold.

33. The apparatus of claim 32, wherein the apparatus is further caused to update the counter value upon detecting one of the invitation acceptance event, the invitation decline event and the invitation ignore event, and, wherein the counter value is updated based on at least one of a first number of visitors from among the one or more visitors to decline the interaction invitations and a second number of visitors from among the one or more visitors to ignore the interaction invitations.
